(19) United States
(12) Patent Application Publication
(10) Pub. No.: US 2017/0175445 A1
(43) Pub. Date: Jun. 22, 2017

(54) WATER STRUCTURE ACCESSORY

(71) Applicant: Maynard H. Brown, JR., Fisher's Landing, NY (US)

(72) Inventor: Maynard H. Brown, JR., Fisher's Landing, NY (US)

(21) Appl. No.: 15/381,172

(22) Filed: Dec. 16, 2016

Related U.S. Application Data
(60) Provisional application No. 62/268,818, filed on Dec. 17, 2015.

(51) Int. Cl. E06C 9/02; F21V 9/08; E02B 3/20

(52) U.S. Cl. CPC E06C 9/02; E02B 3/20; F21V 9/08; F21Y 2115/10

(57) ABSTRACT

A water structure accessory, in an embodiment, comprises at least one primary support, an assistance member comprising at least one handle, and a watercraft securing member comprising at least one flexible tie.

### CROSS-REFERENCE TO RELATED APPLICATION

This application is a non-provisional of, and claims the benefit and priority of, U.S. Provisional Patent Application No. 62/268,818, filed on Dec. 17, 2015. The entire contents of such application are hereby incorporated by reference.

### BACKGROUND

Currently, much of the boarding equipment for watercraft often comprises accessories that are solely attached to the watercraft. However, in many instances a dock or mooring structure may be at a height above the boat such that the known boarding equipment is of little or no use. This is particularly true for small boats in which the user sits at or very close to the surface level of the water. Pulling up to a dock in such a boat poses a problem for the user as the user must stand up, causing the boat to become unsteady, and attempt to hoist himself/herself out of the boat and onto the dock to tie-up the boat. Such a maneuver can be difficult for even the most agile individual to perform without flipping the boat and/or falling off of the boat into the water. Even if one succeeds in climbing up onto the dock, it is likely that the boat will drift or be accidentally pushed away from the dock by the user during the process. Moreover, having the boarding equipment attached solely to the boat results in instability as the user climbs or is assisted onto the dock by the equipment.

Furthermore, the known watercraft boarding equipment that attaches to a dock requires serves only one purpose—boarding. It does not facilitate mooring or securing the boat to the side of the dock. The user must therefore purchasing additional equipment for mooring. This results in greater complexity, cost and required storage space. The extra equipment tends to clutter dock space and can be difficult to use. Moreover, much of the known mooring equipment utilizes rigid mooring arms which can cause damage to the boat and/or dock during rough water. This is because these rigid arms prevent the boat from freely rocking in response to wave action.

The foregoing background describes some, but not necessarily all, of the problems, disadvantages and shortcomings related to boarding, de-boarding and mooring water vehicles at water structures.

### SUMMARY

An embodiment of the water structure accessory of the current disclosure has at least one rigid primary support comprising a water structure engagement portion configured to receive a plurality of fasteners. The water structure accessory also includes an assistance member comprising at least one grasp configured to be positioned above a surface of a water structure supported by water when the water structure engagement portion is coupled to a portion the water structure. The at least one grasp comprises a first grasp end and a second grasp end. The first grasp end and the second grasp end are coupled to the at least one rigid primary support. The water structure accessory further includes a watercraft securing member comprising at least one flexible tie. The at least one flexible tie comprises a first tie end and a second tie end. The first tie end is coupled to the at least one rigid primary support, and the second tie end is configured to be engaged with a watercraft.

In another embodiment of the water structure accessory for watercraft, the water structure accessory comprises at least one rigid primary support comprising a water structure engagement portion configured to couple to a portion of a water structure. The embodiment further includes an assistance portion comprising at least one handle configured to be positioned above a surface of a water structure when the water structure engagement portion is coupled to the portion the water structure. The at least one handle comprises a first handle end and a second handle end. The first handle end and the second handle end are configured to be attached to the at least one rigid primary support at one or more mounting points. The at least one handle comprises at least one coupler configured to keep the at least one handled coupled to the at least one primary support when the at least one handle is subject to a pulling force. The water structure accessory for watercraft also includes a watercraft securing member comprising at least one flexible tie line. The at least one flexible tie line comprising a first tie end and a second tie end, wherein the first tie end is coupled to the at least one rigid primary support, and the second tie end is configured to be coupled to a watercraft.

In still another embodiment, the water structure accessory comprises at least one rigid primary support comprising a water structure engagement portion configured to be coupled to a portion of a water structure. The water structure engagement portion defines a first opening and a second opening. An assistance portion is further includes which comprises at least one grasp comprising a first grasp section configured to be inserted through the first opening, and a second grasp section configured to be inserted through the second opening. The first grasp section and the second grasp section are attached to the at least one rigid primary support. A first stop member is configured to impede disengagement of the first grasp section from the at least one rigid primary support. A second stop member is configured to impede disengagement of the second grasp section from the at least one primary support. the water structure accessory further includes at least one step member coupled to the at least one rigid primary support, and comprising a gripping portion. A water vehicle securing member is further comprises at least one flexible tie line comprising a first tie end coupled to the at least one primary support and a second tie end configured to be coupled to the water vehicle.

Additional features and advantages of the present disclosure are described in, and will be apparent from, the following Brief Description of the Drawings and Detailed Description.

### BRIEF DESCRIPTION OF THE DRAWINGS

FIG. 1 is a front view of an embodiment of the water structure accessory.

FIG. 2 is a side view of a portion of the embodiment of the water structure accessory of FIG. 1.

FIG. 3 is a front view of an embodiment of the water structure accessory.

FIG. 4 is a side view of the water structure accessory of FIG. 3.

FIG. 5 is an enlarged view of an embodiment of the stop member.

FIG. 6 is a front view of an embodiment of the water structure accessory.

FIG. 7 is an isometric view of the embodiment of the water structure accessory of FIG. 6.

FIG. 8 is a front view of an embodiment of the water structure accessory.

FIG. 9 is an enlarged view of another embodiment of the stop member.

### DETAILED DESCRIPTION

The water structure accessory, in an embodiment, assists the user in securing watercraft or water vehicle (e.g., a boat, vessel or jet ski), to a water structure, and the water structure accessory also assists the user in boarding and deboarding from the watercraft. The water structure accessory allows for easy installation and removal from water structures supported by or located in water, including, but not limited to, docks, piers and mooring structures. The water structure accessory is also customizable to account for the physical characteristics of the user as well as characteristics of the environment, such as water level and dock construction.

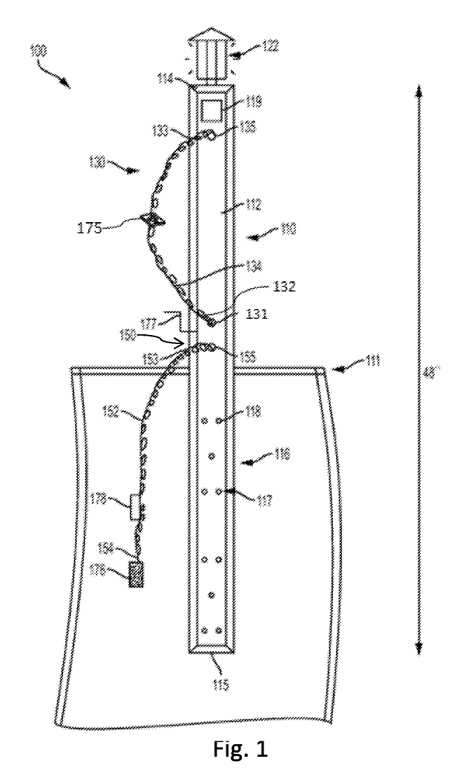

As illustrated in the embodiments of FIGS. 1-5, the water structure accessory 100 comprises an upright or primary support 110, an assistance member 130, a handle device 132, and watercraft securing member 150.

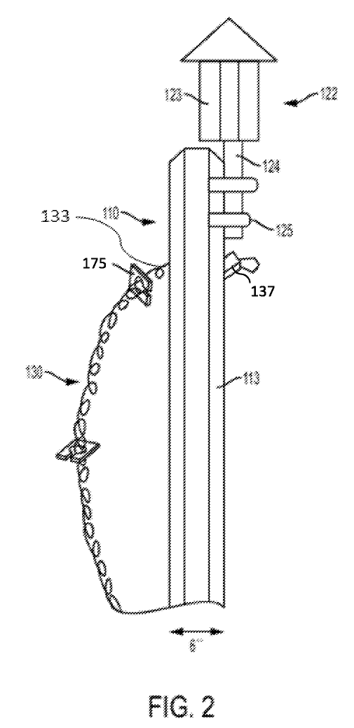

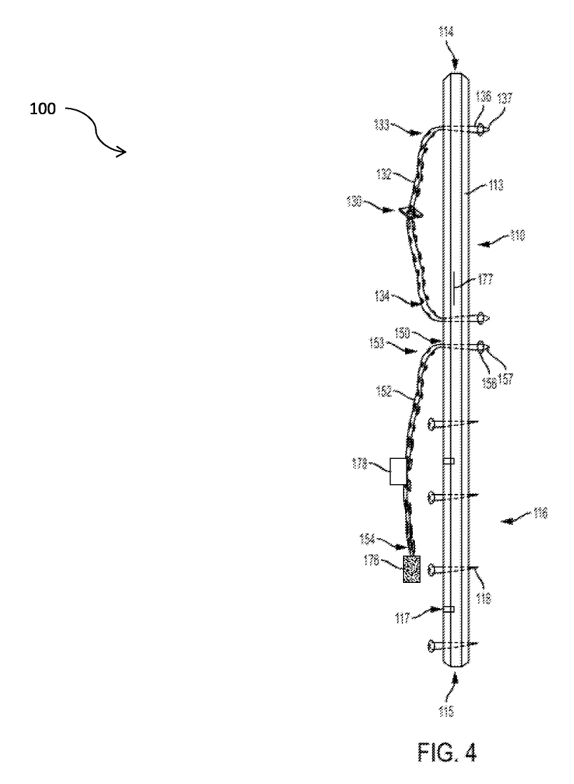

In an embodiment, the primary support 110 comprises a front surface 112, a rear surface 113 (FIGS. 2 and 4), a top surface 114 and a bottom surface 115. The front surface 112 includes grasp mounting points or handle mounting points 131, 135 and a watercraft tie mount 155 (FIGS. 1, and 3-4), as well as a water structure engagement portion or fastening zone 116 (FIGS. 1, and 3-4). In an embodiment, the water structure engagement portion or fastening zone 116 defines a plurality of predrilled openings or holes 117 that can each accept a fastener 118 to secure the primary support 110 to the side of a mooring platform, mooring structure, or water structure 111. The fasteners 118 may be screws, nails, bolts, or any other suitable device to attach the water structure accessory 100 to the water structure 111, thereby securing the engagement between the water structure engagement portion 116 and water structure 111. In another embodiment, the primary support 110 may be secured to the water structure 111 using one or more brackets. In another embodiment, the primary support 110 may be driven into the ground below the surface of the water instead of or in addition to being attached to a portion of the water structure 111. In a further embodiment, the primary support 110 may fit over a piling or support member of the water structure 111 and be fastened to the support member using any of the aforementioned fastening methods as well as any suitable waterproof adhesive or epoxy.

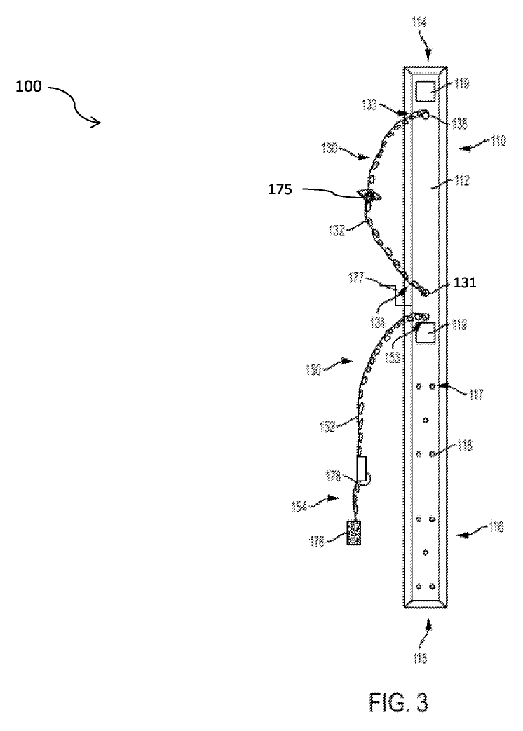

As shown in the embodiments of FIGS. 1-4, the fastening zone 116 is positioned on the lower half of the primary support 110 and configured to accept a plurality of fasteners 118, however the fastening zone may be positioned anywhere on the primary support 110 suitable for securing the water structure accessory 100 to the water structure 111. Referring to FIGS. 1-2, in an embodiment, the primary support 110 is about 48″ long and about 6″ wide, however the primary support 110 may be of different dimensions for use in different situations. As shown in FIGS. 1 and 3, the front surface 112 of the primary support 110 may include one or more markings or decals 119 for branding, safety, or other purposes. The decals 119 may be high visibility or glow-in-the-dark in order to assist the user during evening hours or inclement weather. The primary support 110 may be made from a variety of materials including pressure treated wood, a composite, plastic, PVC pipe, or any other suitable rigid, water proof material.

Referring to FIGS. 1-2, in one embodiment, the primary support 110 includes a light source 122 to illuminate the water structure accessory 100 and the area around it for use during evening hours. The light source 122 may be solar powered, hard wired to an electrical grid, or powered by a battery or any other suitable power source. In addition, the light source 122 may act as a beacon to help the user identify and/or locate his/her destination at night while on the water. In the embodiment shown in FIGS. 1-2, the light source 122 is mounted to the rear surface 113 of the primary support 110 using one or more mounting brackets 124, 125. It should be appreciated that the mounting brackets 124, 125 may include any mounting device suitable for securely attaching light source 122 to the rear surface 113 of the primary support 110. In another embodiment, the light source 122 may be attached to the top surface 114 of the primary support 110. The light source 122 may include one or more colored gels attached to the light panes 123 to make the emitted light any color desired by the user. Alternatively, the light source 122 may include a light emitting diode (LED) of any color desired by the user. In an embodiment, the water structure accessory 100 includes a speaker or sound generator (operable alone or with a motion sensor or light sensor incorporated into accessory 100) to generate a sound. The sound assists the user with locating the primary support 110 and traveling to a position suitable for mooring.

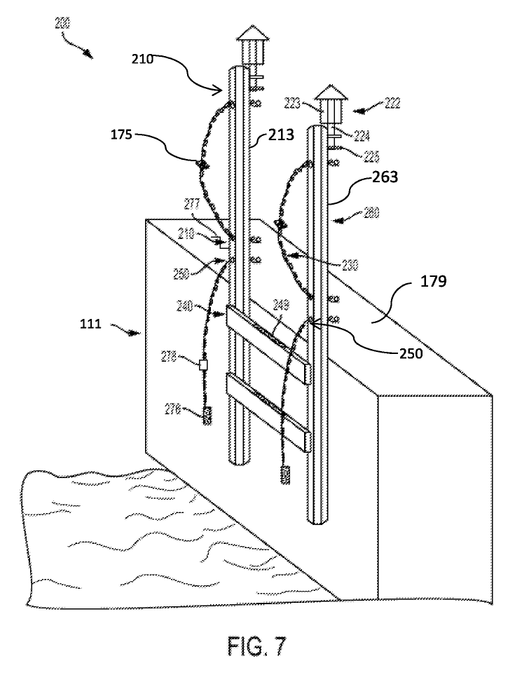

The assistance member 130, as shown in FIGS. 1-4, is positioned on the upper half of the primary support 110. When the water structure accessory 100 is coupled to the water structure 111, the assistance member 130 is positioned above the surface 179 (FIG. 7) of the water structure 111. The assistance grasp or assistance member 130, in an embodiment, comprises a handle or grasp 132 with a grip element 175. The first grasp end 133 of the handle 132 is coupled or anchored to the first grasp mounting point 135 of the primary support 110, and the second grasp end 134 of the grasp 132 is coupled to or anchored to the second grasp mounting point 131 of the primary support 110. In another embodiment not shown, the first and second grasp ends 133, 134 of the grasp 132 may be anchored at the same grasp mounting point of the primary support 110. In the embodiment shown, the grasp 132 is flexible and may be made of rope, cable, cord, tubing, hose or any other flexible waterproof material, however other embodiments of the grasp 132 may be made of a non-flexible material such as a high-density plastic or a metal. For example, in an embodiment not shown, the grasp 132 is a rigid, U-shaped handle constructed or hard plastic or metal. In one embodiment, the grasp 132 may be adjustable along the length of the primary support 110 using a sliding mechanism, a series of locking notches or any other suitable configuration. Other embodiments of the assistance member 130 may include more than one grasps 132 attached to the primary support 110 using a plurality of mounting points. As shown in the embodiment of FIGS. 1-4 and 6-8, the assistance member 130 includes one or more grip elements 175 to further assist the user in holding onto the assistance member 130 during boarding and de-boarding watercraft. In an embodiment, the grip members are adjustably positioned along the length of the grasp 132.

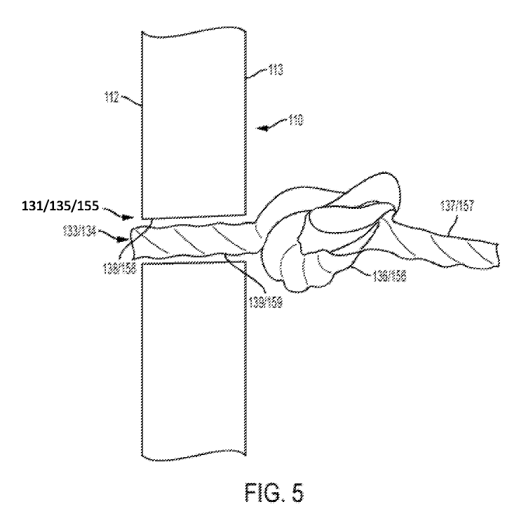

As shown in FIG. 5, in an embodiment, each grasp mounting point 131, 135 of the primary support 110 includes an inner surface 138 that defines the grasp mount opening or grasp mount bore 139 which traverses the thickness of the primary support 110. A portion of the grasp end 133, 134 is passed through the grasp mount bore 139 and fitted with or connected to a grasp stop member or a catch 136, such as a knot tied after the grasp end 133, 134 is inserted through the grasp mount bore 139. The grasp stop member 136 includes a release 137 which allows the grasp 132 to be easily coupled and decoupled to the primary support 110. As shown, the grasp 132, the grasp stop member 136, and the release 137 are a single unitary piece, however in other embodiments they comprise two or more components which are coupled to one another. In other embodiments not shown, the grasp end 133, 134 does not traverse the thickness of the primary support. Sill referring to FIG. 5, the grasp stop member 136, in the embodiment shown, has a diameter that is larger than the diameter of the grasp mount bore 139. When tension is applied to the grasp ends 133, 134, the grasp stop member 136 is pulled against the rear surface 113 of the primary support 110 and prevents the grasp ends 133, 134 from sliding through, or otherwise disengaging from, the primary support 110. In other embodiments, the grasp stop member 136 may consist of a separate member that is attached to the grasp 132 so as to prevent the grasp ends 133, 134 from being pulled away from the primary support 110. It should be appreciated that, in other embodiments, any suitable coupler or fastener can be used to attach the grasp 132 to the primary support 110, including, but not limited to, a bracket, mount plate, bolt or screw.

As shown in FIG. 1, the watercraft securing member 150 is positioned below the assistance grasp 130. Referring to FIGS. 1-4, the watercraft securing member 150 comprises: (a) a watercraft tie line 152 that has a first tie end 153 coupled to the watercraft tie mount 155 of the primary support 110; and (b) a second tie end 154 that is available for engagement with a watercraft.

Referring again to FIG. 5, the watercraft tie mount 155 includes an inner surface 158 that defines the mount bore 159 which traverses the thickness of the primary support 110. Referring to the embodiments of FIGS. 4 and 5, the first tie end 153 of the watercraft tie line 152 is passed through the mount bore 159 and fitted with or connected to a stop member, a catch, or a tie coupler 156. The stop member 156 has a diameter that is larger than the diameter of the mount bore 159. As shown, the stop member 156 is identical to the grasp stop member 136, however in other embodiments the stop member 156 is not identical to the grasp stop member 136. When tension is applied to the watercraft tie line 152, the stop member 156 is pulled against the rear surface 113 of the primary support 110 and prevents the watercraft tie line 152 from pulling through, or otherwise disengaging from, the primary support 110. The watercraft securing member 150 further includes a tie line release 157 which allows the watercraft tie line 152 to be easily coupled and decoupled to the primary support 110. As shown, the watercraft tie line 152, the stop member 156, and the tie line release 157 are a single unitary piece, however in other embodiments they comprise two or more components which are coupled to one another. In other embodiments now shown, the first tie end 153 of the watercraft tie line 152 does not traverse the thickness of the primary support. In the embodiment shown in FIGS. 1, and 3-4, the second tie end 154 of the watercraft tie line 152 is available and configured to be attached to a watercraft in order to prevent the watercraft from drifting away from the water structure 111 as well as to provide some stability to the watercraft during boarding and deboarding. As shown, the watercraft tie line 152 is fully or partially flexible and may be made of rope, cable, cord, tubing, hose or any other flexible or semi-flexible, elongated structure. In other embodiments, the stop member 156 may consist of a separate member (e.g., coupler or fastener) that the watercraft tie line 152 is attached to that prevents the first tie end 153 of the watercraft tie line 152 from being pulled through or away from the primary support 110. It should be appreciated that, in other embodiments, any suitable coupler or fastener can be used to attach the watercraft tie line 152 to the primary support 110, including, but not limited to, a bracket, mount plate, bolt or screw.

In the embodiments shown in FIGS. 1, and 3-4, the watercraft tie line 152 is fully or partially buoyant to assist the user in locating and grabbing the watercraft tie line 152, part of which may be in or on the water. In an embodiment, a float member or buoyant member 176 may be attached to (or incorporated into) the second tie end 154 of the watercraft tie line 152 to assist the user in locating the second tie end 154 of the watercraft tie line 152 when it is in or on the water. The float member or buoyant member 176 can be made of buoyant material such as waterproof foam, plastic or any other suitable material, and can incorporate high-visibility markings or other features to make it easily identifiable by the user during daytime and nighttime use. Depending upon the embodiment, the float member 176 can include a dense material surrounding an air pocket, or the float member 176 can entirely include a relatively low density material. In an embodiment, a hook, clip, or other suitable watercraft tie line engagement member 177 may be attached to the primary support 110 which engages a watercraft tie line fastener 178 that is fitted to the second tie end 154 of the watercraft tie line 152 when the watercraft tie line 152 is not in use. The clip 177 and the watercraft tie line fastener 178 have complementary features such that the watercraft tie line fastener 178 is able to retain the clip 177. The watercraft tie line fastener 178 enables the second tie end 154 of the watercraft tie line 152 to be stored proximate the primary support 110 by the hook or clip 177 so that it is easily located by the user when he or she pulls the watercraft up to the water structure 111. In an embodiment, the watercraft tie line includes a watercraft engagement fastener, hook or bracket (not shown) which allows the user to quickly couple and decouple the tie line to their watercraft. As shown, the embodiments of FIGS. 1-4 have both the float member 176 and the watercraft tie line fastener 178 with the clip 177. In an embodiment, one or more magnetic elements or hook and loop elements (not shown) are attached to (or incorporated into) the second tie end 154 of the watercraft tie line 152 to assist the user with magnetically securing or otherwise securing the second tie end 154 to the watercraft.

When a user moves his/her boat or other watercraft close to the water structure 111 equipped with the water structure accessory 100 (FIGS. 1-4), he/she can immediately and safely secure their watercraft, without having to disembark. The user secures the watercraft to the water structure 111 using the second tie end 154 of the watercraft tie line 152. In some embodiments the user couples the watercraft engagement bracket (not shown) with a complementary bracket (not shown) on the watercraft. Securing the watercraft in this manner prevents the watercraft from drifting away from the water structure 111 and may provide added stability when boarding and disembarking the watercraft. The user then stands up and holds onto the grasp 132 to further steady the watercraft and themselves. Thereafter, the user utilizes the grasp 132 for support in order to safely and easily climb out of the watercraft and onto the water structure 111.

In an embodiment, the primary support 110 includes one or more platforms, steps or toeholds to assist a user in climbing from their watercraft onto the water structure 111. When the user is ready to set out on the water again, he or she simply climbs from the water structure 111 back into their watercraft using the grasp 132 for support and disengages the second tie end 154 of the watercraft tie line 152. In another embodiment, the one or more steps are not attached to the primary support 110 and may be added as separate components to accommodate users and watercraft of various heights and/or water structures 111 of various elevations above the water surface.

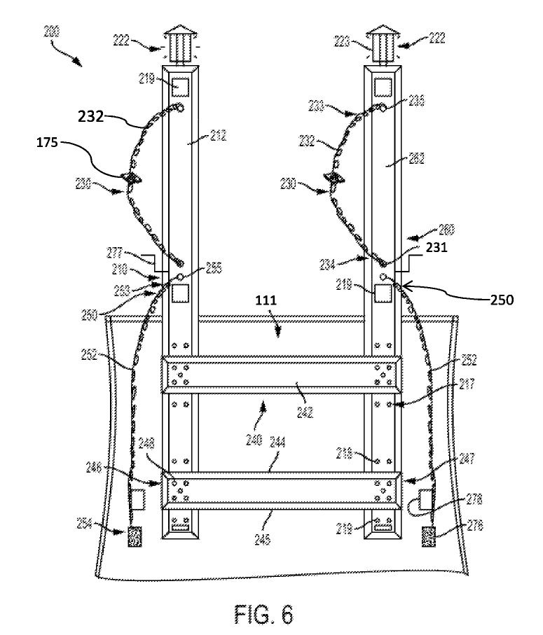

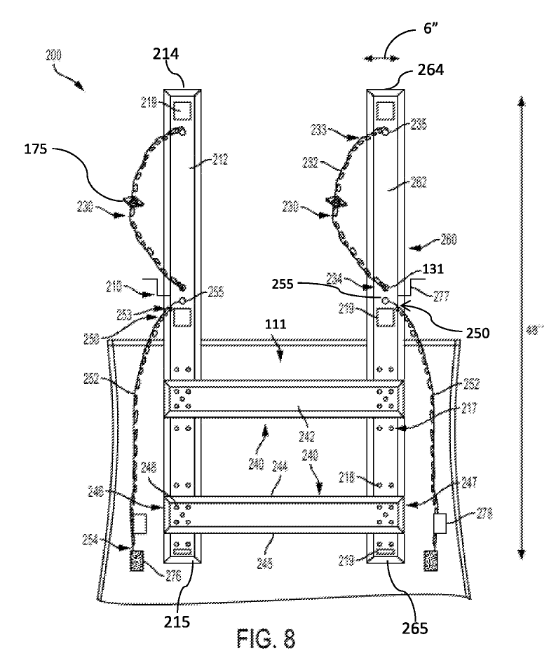

Referring to the embodiments shown in FIGS. 6-8, the water structure accessory 200 may include two primary supports 210, 260, each having a front surface 212, 262 (FIGS. 6 and 8) a rear surface 213, 263 (FIG. 7) a top surface 214, 264 (FIG. 8) and a bottom surface 215, 265 (FIG. 8). In the embodiment shown, the primary supports 210, 260, connected by steps or cross members 240, are arranged to have a ladder structure. As shown, the water structure accessory 200 has an assistance member 230 and a watercraft securing member 250. As shown in FIGS. 6-8, the opposing primary supports 210, 260 are identical, however in other embodiments, the opposing primary supports are not identical.

The front surface 212, 262 of each of the primary supports 210, 260 includes grasp mounting points 231, 235, watercraft tie mounting point 255 as well as a water structure attachment portion or a fastening zone 216. The fastening zone 216 includes a plurality of predrilled openings or holes 217 that can each accept a fastener 218 in order to secure the primary supports 210, 260 to the side of a water structure or mooring structure 111. In other embodiments, the primary supports 210, 260 may be secured to the water structure 111 using one or more brackets. In another embodiment the primary supports 210, 260 may be driven into the ground below the surface of the water instead of or in addition to being attached to a portion of the water structure 111. As shown, the fastening zone 216 is positioned on the lower half of each of the primary supports 210, 260 and configured to accept a plurality of fasteners 218, however it should be appreciated that the fastening zone 216 may be positioned anywhere on the primary supports 210, 260 suitable for securing the water structure accessory 200 to a water structure 111. In a further embodiment, one or more of the primary supports 210, 260 may fit over a piling or support member of the water structure 111 and be fastened to the support member using any of the aforementioned fastening methods as well as any suitable waterproof adhesive or epoxy.

As shown in FIG. 8, in an embodiment, the primary supports 210, 260 are about 48″ long and about 6″ deep, however primary supports 210, 260 of different dimensions may be used for different situations. The front surface 212 of the primary supports 210, 220 may include one or more markings or decals 219 for branding, safety or other purposes (FIGS. 6 and 8). The decals 219 may be high visibility or glow-in-the-dark in order to assist the user during evening hours or inclement weather. As shown, the primary supports 210, 260 are identical, however in other embodiments, opposing primary supports 210, 260 may not be identical and may have one or more features that are different from one another. The primary supports 210, 260 may be made from a variety of material including pressure treated wood, a composite, plastic, PVC pipe or any other suitable rigid, water proof material.

Referring to FIGS. 6-7, in one embodiment, each of the primary supports 210, 260 may include a light source 222 to light the water structure accessory 200 and the area around for use during evening hours. Each light source 222 may be solar powered, hard wired, or powered by any other suitable power source. The light sources 222 may also act as a beacon to help the user identify and/or locate their destination at night while on the water. As shown, the light sources 222 are each attached to the rear surface 213, 263 (FIG. 6) of the primary supports 210, 260 using one or more mounting brackets 224, 225. It should be appreciated, however, that the mounting brackets 225 may include any mounting device suitable for securely attaching the light sources 222 the rear surfaces 213, 263 of the primary supports 210, 260. In another embodiment, the light sources 222 may be attached to the top surface 214, 264 (FIG. 8) of the primary supports 210, 260. In another embodiment, the water structure accessory 200 may have only one light source 222. It can be appreciated that the light sources 222 may include one or more colored gels attached to the light panes 223 to make the emitted light any color desired by the user. Alternatively, each light source 222 may include a light emitting diode (LED) of any color desired by the user. In an embodiment, the water structure accessory 200 includes a speaker or sound generator (operable alone or with a motion sensor or light sensor incorporated into the water structure accessory 200) to generate a sound. The sound assists the user with locating the primary support 2 210, 260 and traveling to a position suitable for mooring.

Still referring to FIGS. 6-8, an assistance member 230 is positioned on each of the primary supports 210, 260. When coupled to the water structure 111, the assistance member 230 of at least one of the primary supports 210, 260 is positioned above the platform surface of the water structure 111. The assistance member 230 includes two grasps 232 that are anchored at each end to a grasp mounting point 231, 235 of the primary supports 210, 260. In another embodiment the first and second ends 233, 234 of the grasp 232 may be anchored at the same grasp mounting point of the primary supports 210, 260. In another embodiment the first and second ends 233, 234 of the grasp 232 may be anchored at the same grasp mounting point. As shown, each primary support 210, 260 includes one grasp 232, however other embodiments may include more than one grasp on each primary support 210, 260. As shown in the embodiments of FIGS. 6-8, the grasps 232, are oriented along the length of the primary supports 210, 260, however in other embodiments, the grasps 232 may not be oriented along the length of the primary supports 210, 260. In the embodiments of FIGS. 6-8, the grasps are flexible and may be made of rope, cable, cord, tubing, hose or any other flexible waterproof material. However, in other embodiments the grasps may be made of a non-flexible material such as a high-density plastic or a metal. For example, in an embodiment not shown, the grasp 232 is a rigid, U-shaped handle constructed or hard plastic or metal. In one embodiment, the grasps 232 may be adjustable along the length of the primary supports 210, 260 using a sliding mechanism, a series of locking notches or any other suitable mechanism which allows the grasps to be adjusted. As shown in FIGS. 6-8, the grasps 232 are identical, however in other embodiments, the grasps 232 may not be identical and may vary in shape, size and composition. In an embodiment, the grip members are adjustably positioned along the length of the grasp 232. It should be appreciated that, in other embodiments, any suitable coupler or fastener can be used to attach the grasp 132 to the primary support 110, including, but not limited to, a bracket, mount plate, bolt or screw.

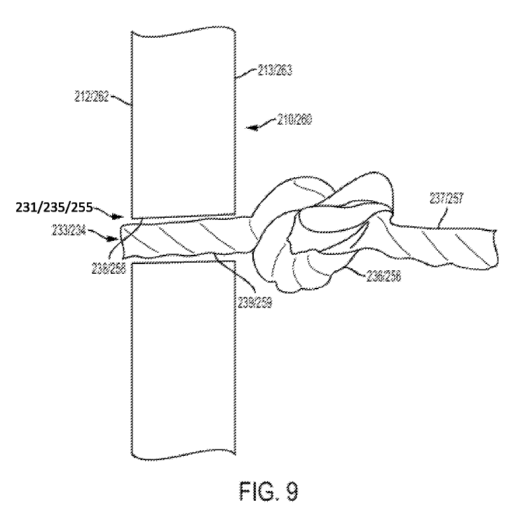

As shown in FIG. 9, each grasp mounting point 231, 235 of the primary supports 210, 260 includes an inner surface 238 that defines the grasp mount bore 239 which traverses the thickness of the respective primary support 210, 260. In other embodiments, the grasp end 233, 234 may not traverse the thickness of the primary support 210, 260. As shown in FIG. 9, the grasp end 233, 234 of each grasp 232 is passed through the grasp mount bore 239 and fitted with a grasp stop member or a catch 236. The grasp stop member 236 has a diameter that is larger than the diameter of the grasp mount bore 239. Each grasp stop member 236 includes a release 237 which allows the grasp 232 to be easily coupled and decoupled from each of the primary supports 210, 260. As shown, the grasp 232, the grasp stop member 236, and the release 237 are a single unitary piece, however in other embodiments they comprise two or more components which are coupled to one another. When tension is applied to the grasp ends 233, 234, the grasp stop member 236 is pulled against the rear surface 213, 263 of the primary support 210, 260 and prevents the grasp ends 233, 234 from sliding through or otherwise disengaging from their respective primary support 210, 260. In other embodiments, the grasp stop member 236 may consist of a separate member that is attached to the grasp 232 so as to prevent the grasp ends 233, 234 from being pulled away from the respective primary support 210, 260. As shown in FIGS. 6-8, the grasps 232 are identical, however in other embodiments the grasps 232 may not be identical and/or may be positioned at different locations along the primary supports 210, 260.

Referring to the embodiments of the water structure accessory 200 shown in FIGS. 6-8, one or more platforms, steps, or cross members 240 are attached to each of the primary supports 210, 220. As shown, the steps or cross members 240 are connected to the primary supports 210, 260, extending from primary support 210 to primary support 260. The cross members 240 enable the user to step on cross members 240 to climb up to the surface 179 (FIG. 7) of the water structure 111. In an embodiment, the cross members 240 have a front surface 242, a rear surface, 243, a top surface 244 and a bottom surface 245. As shown, the first end 246 of each cross member 240 is attached to a surface of one primary support 210 and the second end 247 of each cross member 240 is attached a surface of the other primary support 260. The cross members 240 are attached at each end 246, 247 to one of the primary supports 210, 260 using a plurality of fasteners 248. The fasteners 248 may be the same as the fasteners 218 that are used in the fastening zone 216, or they may be another type of fastener such as a carriage bolt, a glued dowel, or any other type of fastener that would be appropriate for fastening each end 246, 247 of the cross members 240 to the primary supports 210, 220. The steps or cross members 240 assist the user in climbing up from a watercraft on the surface of the water to the surface of a water structure or mooring structure 111.

The top surface 244 of each step or cross member 240 may include a friction surface or a textured or gripping portion 249 (FIG. 7). The gripping portion 249 allows the user's feet to gain traction when the cross members are slippery due to wetness from the water below or precipitation. The gripping portion 249 and its corresponding cross member 240 may be a single unitary piece, or the gripping portion 249 may be a separate component that is attached to the top surface 244 of the cross member 240 using a waterproof adhesive, epoxy, or any other type of fastening method that is water proof and suitable for attaching the gripping portion 249 to the top surface 244 of the cross member 240.

Referring to the embodiments shown in FIGS. 6-8, the watercraft securing member 250 is positioned below the grasps 232 of the assistance member 230, however in other embodiments the watercraft securing member 250 may not be positioned below the grasp 232. As shown in FIGS. 6-8, the watercraft securing member 250 comprises two watercraft tie lines 252 and two watercraft tie mounts 255 of the primary supports 210, 260. Another embodiment of the water structure accessory 200 may not include two watercraft tie lines 252. In the embodiments shown in FIGS. 6-8, the watercraft tie lines 252 are identical and each have a first end 253 and a second tie end 254. In other embodiments of the water structure accessory 200, the watercraft tie lines may not be identical. Each watercraft tie line 252 is attached to the watercraft tie mounts 255 of the primary support 210, 260 at the first end 253 as shown in FIGS. 6-8. In one embodiment, each watercraft tie mount 255 includes an inner surface 258 that defines the mount bore 259 which traverses the thickness 226 of the primary supports 210, 260 (FIG. 9). As shown in FIG. 9, the first end 253 of each watercraft tie line 252 is passed through the mount bore 259 and is fitted with a watercraft tie stop, a catch, or a tie coupler 256. The watercraft tie stop 256 has a diameter that is larger than the diameter of the mount bore 259 and thereby, secures the watercraft tie lines 252. When tension is applied to the watercraft tie lines 252, the watercraft tie stop 256 is pulled against a portion of the rear surface 213, 263 of the primary supports 210, 260 that surrounds each mount bore 259. The watercraft tie stop 256 includes a release member 257 which allows the watercraft tie line 252 to be easily coupled and decoupled to the primary support 210, 260. As shown, the watercraft tie line 252, the watercraft tie stop 256, and the release member 257 are a single unitary piece, however in other embodiments they comprise two or more components which are coupled to one another. The second tie end 254 of the watercraft tie line 252 is available to be attached to one a watercraft in order to prevent the watercraft from drifting away from the water structure or other such mooring structure 111.

In the embodiments shown in FIGS. 6-8, each watercraft tie line 252 is fully or partially buoyant to assist the user in locating and grabbing the watercraft tie line 252, part of which may be in the water. In an embodiment, a float member or buoyant member 276 may be attached to the second tie end 254 of the watercraft tie line 252 to assist the user in locating the second tie end 254 of the watercraft tie line 252 when it is in the water. The float member 276 is made of buoyant material such as waterproof foam, plastic or any other suitable material, and may incorporate high-visibility markings or other features to make it easily identifiable by the user during daytime and nighttime use. Depending upon the embodiment, the float member 276 can include a dense material surrounding an air pocket, or the float member 276 can entirely include a relatively low density material. In an embodiment, a hook, clip, or other suitable watercraft tie line engagement member 277 may be attached to the primary support 210, 260 that engages a watercraft tie line fastener 278 that is fitted to the second tie end 254 of the watercraft tie line 252 when the watercraft tie line 252 is not in use. The clip 277 and the watercraft tie line fastener 278 have complementary features such that the watercraft tie line fastener 278 is able to retain the clip 277. The watercraft tie line fastener 278 enables the second tie end 254 of the watercraft tie line 252 to be stored proximate the primary support 210, 260 by the hook or clip 277 so that it is easily located by the user when he or she pulls their boat up to the water structure 111. In an embodiment, each watercraft tie line includes a watercraft engagement bracket (not shown) which allows the user to quickly couple and decouple the tie lines to their watercraft. As shown, the embodiments of FIGS. 6-8. have both the float member 276 and the watercraft tie line fastener 278 with the clip 277. In an embodiment, one or more magnetic elements or hook and loop elements (not shown) are attached to (or incorporated into) the second tie end 254 of the watercraft tie line 252 to assist the user with magnetically securing or otherwise securing the tie end 254 to the watercraft.

When the user pulls his/her boat or other watercraft up to the water structure or mooring structure 111 equipped with the water structure accessory, they can immediately secure their watercraft to the water structure without having to disembark. In some embodiments the user couples the watercraft engagement hook, fastener, or bracket (not shown) with a complementary hook, fastener, or bracket (not shown) on the watercraft. The user secures their watercraft to the water structure 111 using the second tie end 254 of one or both of the watercraft tie lines 252. Securing the watercraft using one or both of the watercraft tie lines 252 prevents the watercraft from drifting away from the water structure and may provide added stability when boarding and disembarking the watercraft. The user then stands up and holds onto the grasps 232 or the cross members 240 for support and to further steady the watercraft. Next, the user steps onto the top surface 244 of the cross member 240 and uses the grasps 232 for support to safely and easily climb onto the water structure 111. When the user is ready to set out on the water again, he or she simply climbs from the surface of the water structure 111 back into their watercraft using the top surface 244 of the cross members 240 and grasps 232 for support. The user then disengages the second tie end(s) 254 of the watercraft tie line(s) 252 as sets out into open water.

Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claim. Moreover, although specific terms are employed herein, as well as in the claim which follows, they are used only in a generic and descriptive sense, and not for the purposes of limiting the present disclosure, nor the claim which follows.

The following is claimed:

1. A water structure accessory comprising:
at least one rigid primary support comprising a water structure engagement portion configured to receive a plurality of fasteners;
an assistance member comprising at least one grasp configured to be positioned above a surface of a water structure supported by water when the water structure engagement portion is coupled to a portion the water structure, the at least one grasp comprising a first grasp end and a second grasp end, wherein the first grasp end and the second grasp end are coupled to the at least one rigid primary support; and
a watercraft securing member comprising at least one flexible tie, the at least one flexible tie comprising a first tie end and a second tie end, wherein the first tie end is coupled to the at least one rigid primary support, and the second tie end is configured to be engaged with a watercraft.

2. The water structure accessory of claim 1 further comprising one or more steps connected to the at least one rigid primary support.

3. The water structure accessory of claim 2, wherein each of the one or more steps comprises a gripping portion.

4. The water structure accessory of claim 1, wherein the watercraft securing member comprises a buoyant member configured to keep a portion of the watercraft securing member at or above a level of the water.

5. The water structure accessory of claim 1, wherein the at least one grasp comprises at least one gripping element.

6. The water structure accessory of claim 1 comprising at least one light source mounted to the at least one rigid primary support.

7. The water structure accessory of claim 1, wherein:
the at least one rigid primary support defines an opening configured to receive a grasp portion of the at least one grasp; and
the first grasp end of the at least one grasp comprises the grasp portion and at least one stop member connected to the grasp portion, wherein the at least one stop member is configured to prevent the grasp portion from being separated from the at least one rigid primary support.

8. A water structure accessory for watercraft, the water structure accessory comprising:
at least one rigid primary support comprising a water structure engagement portion configured to couple to a portion of a water structure;
an assistance portion comprising at least one handle configured to be positioned above a surface of a water structure when the water structure engagement portion is coupled to the portion the water structure, the at least one handle comprising a first handle end and a second handle end, wherein the first handle end and the second handle end are configured to be attached to the at least one rigid primary support at one or more mounting points, and wherein the at least one handle comprises at least one coupler configured to keep the at least one handled coupled to the at least one rigid primary support when the at least one handle is subject to a pulling force;
a watercraft securing member comprising at least one flexible tie line, the at least one flexible tie line comprising a first tie end and a second tie end, wherein the first tie end is coupled to the at least one rigid primary support, and the second tie end is configured to be coupled to a watercraft.

9. The water structure accessory of claim 8, including one or more cross members coupled to the at least one rigid primary support, each of the one or more cross members comprising a gripping portion.

10. The water structure accessory of claim 8, wherein the flexible tie line comprises a buoyant member configured to keep a portion of the flexible tie line at or above a level of the water.

11. The water structure accessory of claim 8, wherein the at least one handle comprises at least one gripping element.

12. The water structure accessory of claim 8, comprising at least one light source coupled to the at least one rigid primary support.

13. The water structure accessory of claim 8, wherein the at least one rigid primary support comprises a tie line securing member configured to secure the second tie end to the watercraft.

14. The water structure accessory of claim 8, wherein the at least one flexible tie line comprises at least one tie coupler configured to prevent disengagement of the at least one flexible tie line from the at least one rigid primary support.

15. The water structure accessory of claim 8, wherein the at least one flexible tie line comprises a watercraft engagement bracket configured to be coupled to a portion of the watercraft.

16. A water structure accessory comprising:
at least one rigid primary support comprising a water structure engagement portion configured to be coupled to a portion of a water structure, wherein the water structure engagement portion defines a first opening and a second opening;
an assistance portion comprising:
at least one grasp, the at least one grasp comprising a first grasp section configured to be inserted through the first opening and a second grasp section configured to be inserted through the second opening, wherein the first grasp section and the second grasp section are attached to the at least one rigid primary support;
a first stop member configured to impede disengagement of the first grasp section from the at least one rigid primary support;
a second stop member configured to impede disengagement of the second grasp section from the at least one rigid primary support;
at least one step member coupled to the at least one rigid primary support, the at least one step member comprising a gripping portion; and
a water vehicle securing member comprising at least one flexible tie line, the at least one flexible tie line comprising a first tie end coupled to the at least one rigid primary support and a second tie end configured to be coupled to the water vehicle.

17. The water structure accessory of claim 16, wherein the second tie end comprises a buoyant member configured to keep a portion of the second tie end at or above a water surface.

18. The water structure accessory of claim 16, wherein the at least one grasp comprises at least one gripping element.

19. The water structure accessory of claim 16, wherein the at least one flexible tie line comprises a watercraft engagement bracket configured to be coupled to a portion of a water vehicle.

20. The water structure accessory of claim 16, comprising at least one light source coupled to the at least one rigid primary support.
